(19) United States
(12) Patent Application Publication
(10) Pub. No.: US 2006/0152847 A1
(43) Pub. Date: Jul. 13, 2006

(54) Optical disc drive with integral hard disk cache drive

(76) Inventors: Enrique M. Stiles, Imperial Beach, CA (US); Richard C. Calderwood, Portland, OR (US)

Correspondence Address: RICHARD C. CALDERWOOD, 2775 NW 126TH AVE, PORTLAND, OR, 97229-8381, US

(21) Appl. No.: 11/370,488

(22) Filed: Mar. 7, 2006

Related U.S. Application Data
(62) Division of application No. 10/933,091, filed on Sep. 1, 2004, now abandoned.

(51) Int. Cl. G11B 17/00

(52) U.S. Cl. 360/97.01

(57) ABSTRACT

An optical disc drive including, in a separate sealed chamber, a magnetic disk drive which serves as a cache for the optical disc drive. The optical disc and the magnetic disk are carried on separate spindles which are non-coaxial. Optionally, the optical disc and the magnetic disk overlap.

### RELATED APPLICATION

This application is a divisional of application Ser. No. 10/933,091 “Hard Disk Drive with Multiple Spindles” filed Sep. 1, 2004 by these inventors.

### BACKGROUND OF THE INVENTION

1. Technical Field of the Invention

This invention relates generally to rotating storage devices, and more specifically to a storage device having more than one spindle carrying media disks.

2. Background Art

FIGS. 1, 2, and 3 illustrate a hard disk drive 10 such as is well known in the computer and related industries. The hard disk drive includes a chassis 12 which supports the other components of the hard disk drive. Together with a cover or lid (not shown), the chassis encloses a sealed chamber 14. Inside the sealed chamber, a rotating platter or disk 18 is carried on an axle, generally referred to as a spindle 20. Data are written to and read from the platter by a head 22 which is carried by a servo-driven armature 24. The armature pivots about its own axle 26.

For ease of illustration, the various linear and rotating transducer motors which drive the armatures and spindles, the various electronic components, and the various connectors are not shown in the drawings. Those of ordinary skill in the art well understand what these are and how they fit into the system.

The size of the platter is limited by, among other things, the internal dimensions of the body of the hard disk drive. One common form factor is the so-called 3.5″ drive which is used in personal computers and other common applications. The external dimensions of a 3.5″ drive are 4″ wide and 5.75″ deep. The height does not directly impact the size of the platter, but is generally 1″. If a manufacturer wishes to sell its hard disk drive product into industry standard form factor systems such as personal computers, the product needs to conform to the industry standard sizing.

Using a single spindle and a single armature minimizes the cost of the hard disk drive, and maximizes its mean time before failure (MTBF). The more moving parts the drive has, the costlier and the less reliable it will be.

However, as component manufacturing becomes more efficient, the cost of the parts tends to decrease over time. And as component manufacturing becomes more mature, the reliability of the parts tends to increase over time.

What would be desirable would be an improved hard disk drive whose bill of materials has been optimized based on other parameters, such as performance.

### BRIEF DESCRIPTION OF THE DRAWINGS

FIGS. 1, 2, and 3 show a single-spindle hard disk drive according to the prior art, in perspective view, top view, and cutaway view, respectively.

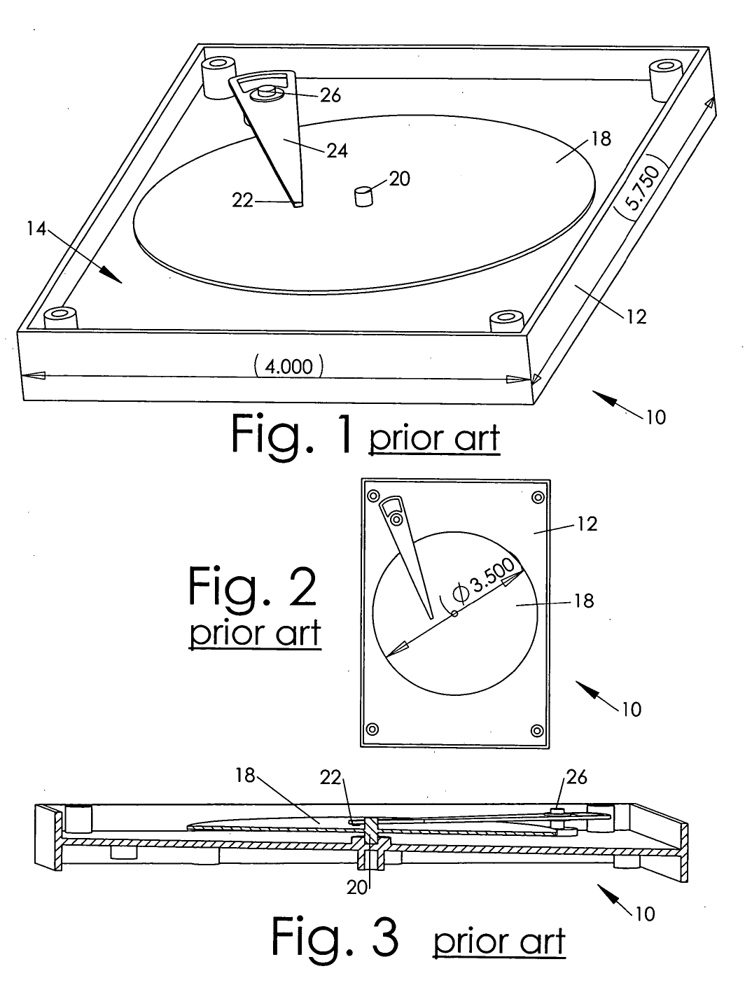

FIGS. 4, 5, and 6 show a multi-spindle hard disk drive according to one embodiment of this invention, in which the platters rotate in opposite directions.

FIGS. 7, 8, and 9 show a multi-spindle hard disk drive according to another embodiment of this invention, in which the platters rotate in the same direction.

FIGS. 10, 11, and 12 show a multi-spindle hard disk drive in which the counter-rotating platters overlap each other, and in which the chassis is stepped.

FIGS. 13, 14, and 15 show a multi-spindle hard disk drive in which the platters rotate in the same direction and overlap each other.

FIG. 16 shows a multi-spindle disk drive in which the platters have different sizes and different rotational speeds, and in which one may be removable, and in which one serves as a cache or buffer for the other.

FIGS. 17-19 show another embodiment of a multi-spindle disk drive in which one of the spindles is coupled to an upper half of the housing and another is coupled to a lower half of the housing.

FIGS. 20-22 show another embodiment in which the housing halves couple together in a different manner.

### DETAILED DESCRIPTION

The invention will be understood more fully from the detailed description given below and from the accompanying drawings of embodiments of the invention which, however, should not be taken to limit the invention to the specific embodiments described, but are for explanation and understanding only.

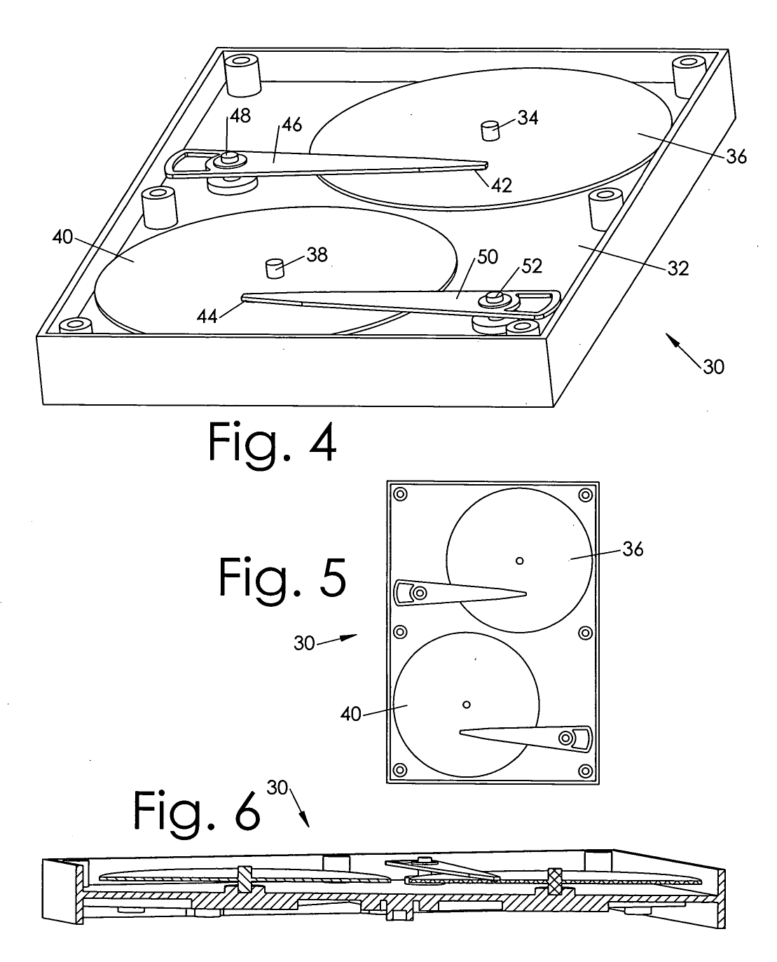

FIGS. 4, 5, and 6 illustrate a hard disk drive 30 according to one embodiment of this invention. The hard disk drive includes a chassis 32 which supports the other components of the drive in a sealed environment. The hard disk drive includes a first spindle 34 carrying one or more media platters or disks 36 and a second spindle 38 carrying one or more platters 40. Data are written to and read from the first platter by a first head 42, and written to and read from the second platter by a second head 44. The first head is carried by a first armature 46 which pivots about a first axle 48. The second head is carried by a second armature 50 which pivots about a second axle 52.

Each platter is smaller than the 3.5″ platter of the prior art, even though the body is the same size as required by the prior art industry standard. In one embodiment, each platter is 2.75″ in diameter. In other embodiments, other sizes may be found suitable. The platters may be, but are not required to be, the same diameter on both spindles. The platters may be, but are not required to be, coplanar, which may enable more platters to be stacked within the same height drive. Co-planar platters, or at least non-overlapping platters, will ease the assembly of the drive. The first and second spindles and platters may be constructed using two sets of identical components, reducing the number of different parts in the bill of materials.

In the embodiment shown, the spindles rotate in opposite directions; the first platter 36 rotates counter-clockwise, and the second platter 40 rotates clockwise. This offers the advantage that the boundary layer wind will be in the same direction in the region where the platters are nearest each other, minimizing disturbances on the platters and heads.

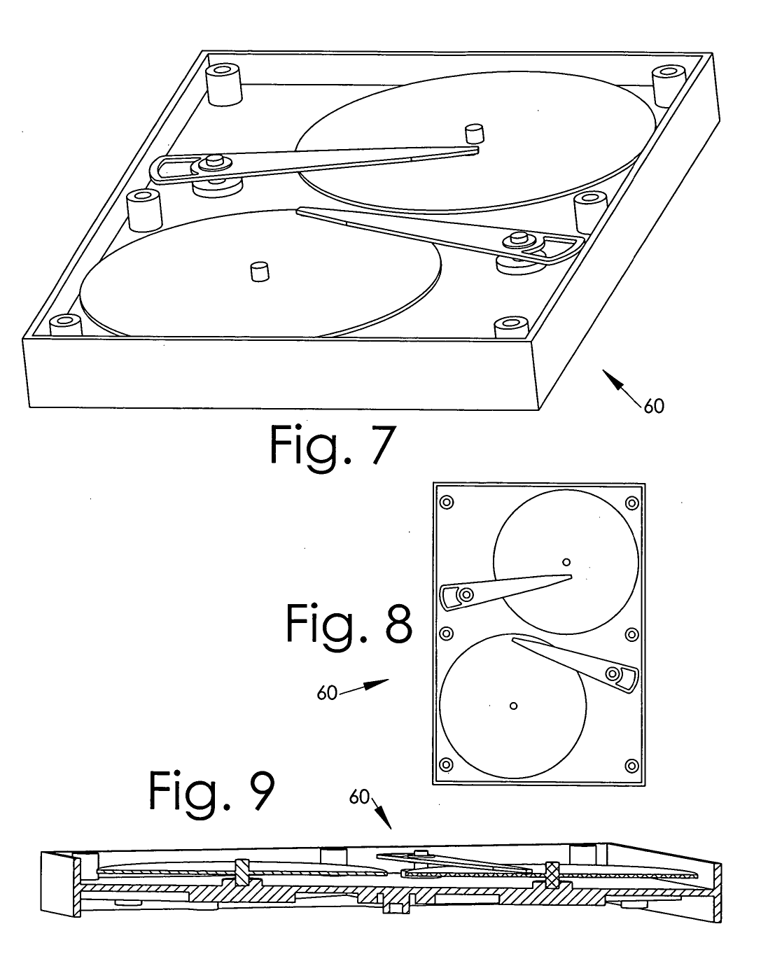

FIGS. 7, 8, and 9 illustrate an embodiment of a multi-spindle hard disk drive 60 in which the spindles rotate in the same direction. One advantage of this configuration is that the spindles can use the same sku motor, reducing the different parts count in the bill of materials.

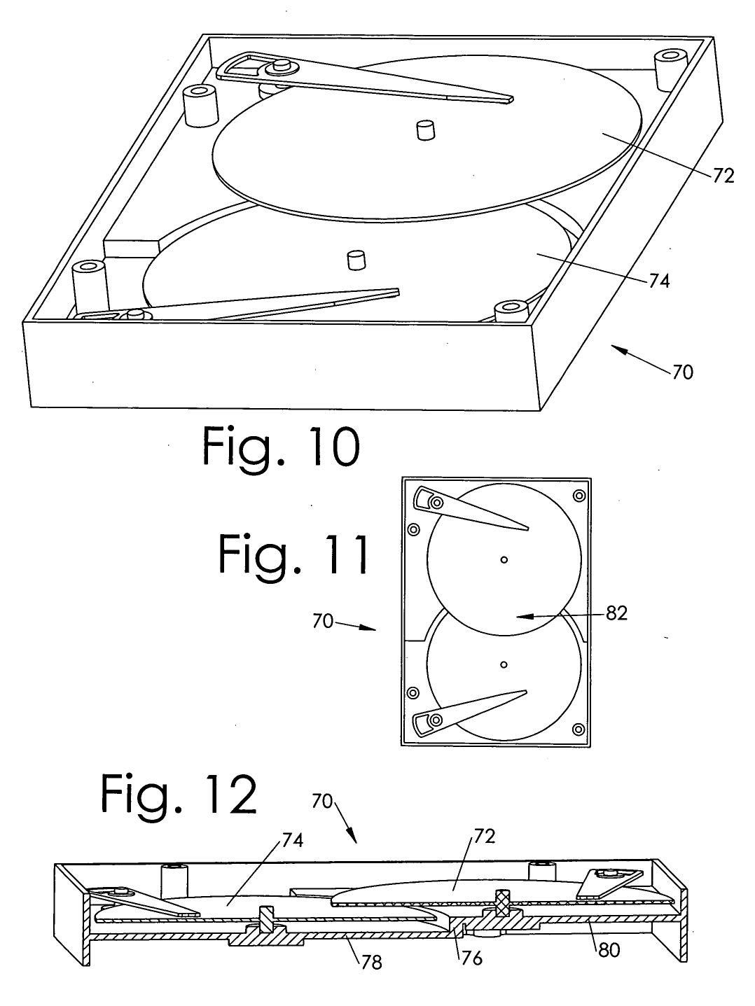

FIGS. 10, 11, and 12 illustrate another embodiment of a multi-spindle hard disk drive 70 in which the first platter(s) 72 overlap the second platter(s) 74. Overlapping enables the use of somewhat larger platters, increasing the total capacity of the hard disk drive.

The platters in this embodiment are larger than in the first embodiment, such as 3″. So large, in fact, that they must overlap in a central region 82 in order to fit within the body of the drive. In order to accomplish this, the platters must be vertically staggered, one above the other, with sufficient clearance between them to prevent collisions or rubbing or other interference. In some such embodiments, the clearance required between the platters can be reduced by positioning the armatures and their axles such that the heads do not need to enter the region of overlap but are still able to sweep the entire storage surface area.

In one embodiment, the overlapping is accomplished by using spindles having different dimensions. In another embodiment, such as that shown, the overlapping is accomplished by adding a step 76 to the chassis, such that the first platter 72 is supported by a higher portion 80 of the chassis and the second platter 74 is supported by a lower portion 78 of the chassis.

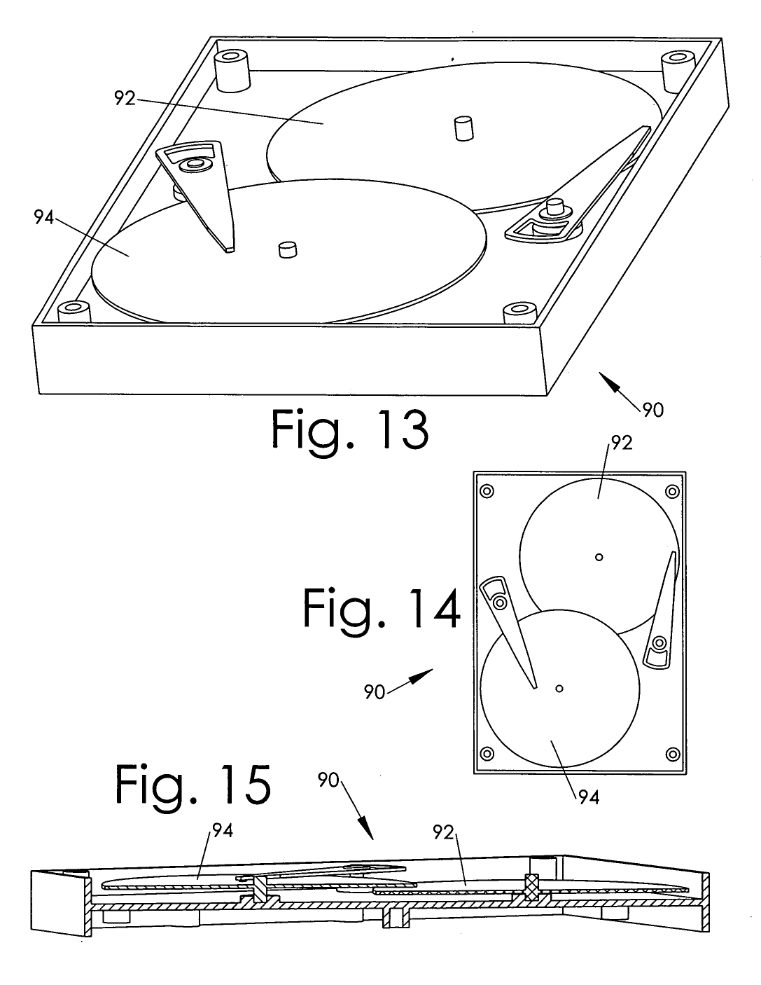

FIGS. 13, 14, and 15 illustrate another embodiment of a multi-spindle hard disk drive 90 with overlapping platters 92, 94 which rotate in the same direction.

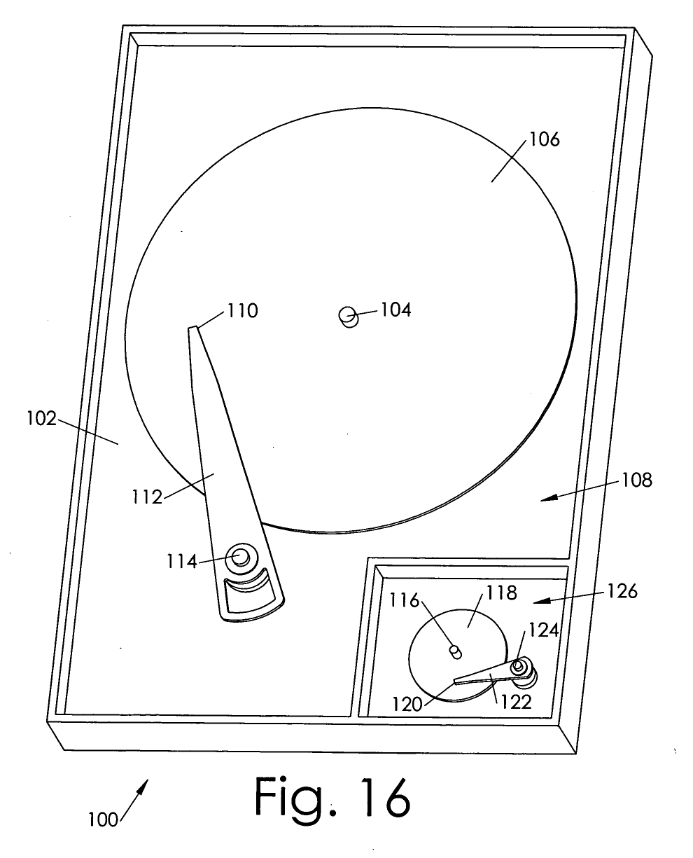

FIG. 16 illustrates another embodiment of a multi-spindle disk drive 100. The disk drive includes a chassis 102 which supports a first disk having a first spindle 104 carrying one or more first platters 106 in a first chamber 108 which may optionally be sealed. A first head 110 reads and writes the first platter and is carried on a first armature 112 which rotates on a first axle 114.

A second disk has a second spindle 116 carrying one or more second platters 118. The second platters are written and read by a second head 120 which is carried on a second armature 122, which in turn rotates on a second axle 124. Optionally, the second platter may be in a second sealed chamber 126.

The second platter may be much smaller than the first platter, and may rotate at a significantly higher speed and thus have a significantly reduced latency and significantly increased throughput. The second disk may advantageously be used as a cache and/or a buffer for the first disk. By using a rotating disk as a cache or buffer, the drive is able to have a vastly larger cache or buffer capacity than in the prior art. In one embodiment, the first disk is removable. In one embodiment, the first disk is an optical media disk, while the second disk is a magnetic media disk.

In one embodiment, in which the larger disk and the smaller disk are both e.g. magnetic hard disks, the smaller disk may be able to cache some significant percentage of the larger disk's capacity, such as 5% or more. By way of contrast, current hard disk drives may have a capacity of 250 Gigabytes with a solid state RAM cache of only 8 Megabytes; the cache holds a mere 0.0032% of the disk's contents.

It is not necessarily the case that the smaller disk have smaller capacity. For example, the smaller disk may be a 5 Gigabyte magnetic hard disk, while the larger disk may be a CD-R disk (700 Megabytes typical capacity) or a DVD+RW disk (4.7 Gigabytes typical capacity). In such a situation, the smaller disk will typically be used as a write-back cache.

In some embodiments, there may be two or more of the smaller disks (on separate spindles), space permitting. These may optionally be operated as a RAID device, such as a RAID 0 striped drive, offering even more improvement in throughput speed.

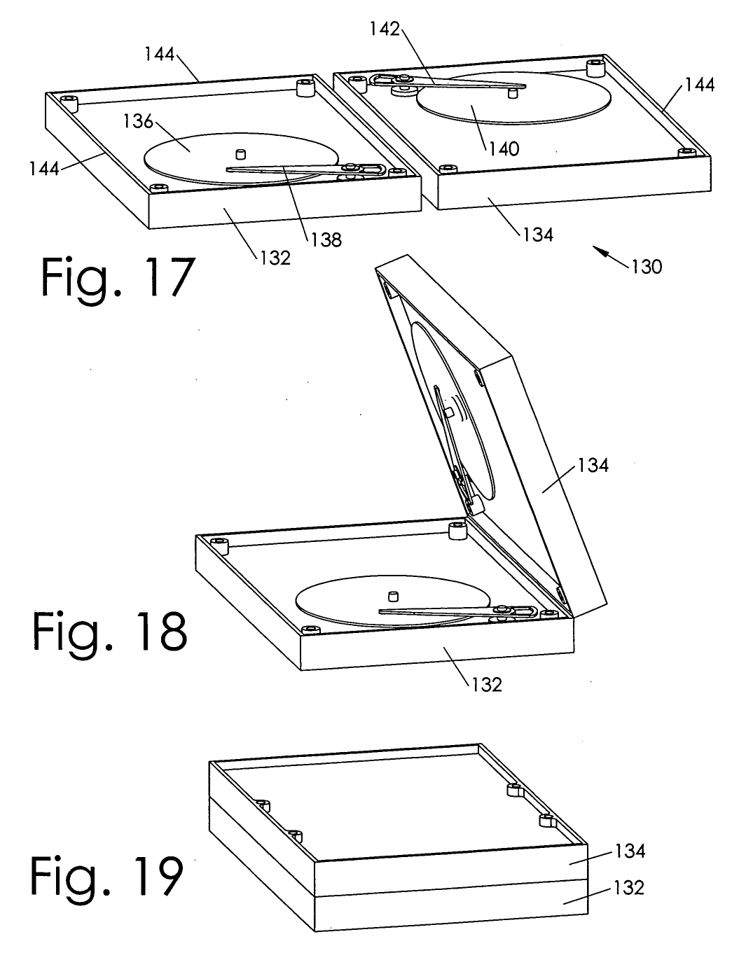

FIGS. 17-19 illustrate another embodiment of a multi-spindle hard disk drive 130 in which the disk drive housing or chassis is comprised of a lower housing half 132 and an upper housing half 134 which couple together. A first spindle 136 and a first armature 138 are coupled to the lower housing half, and a second spindle 140 and a second armature 142 are coupled to the upper housing half. The housing halves mate together at a mating surface 144.

In one such embodiment, the motors (not shown) which drive the two spindles are constructed to rotate in the same direction (e.g. both rotate clockwise when viewed from the platter side of the housing half), so that the portions of the platters which overlap in the middle are rotating in the same linear direction. This also permits the use of the same motor component in each housing half.

In another such embodiment, in which the platters are more overlapped, such that each extends well beyond the spindle of the other, it may be desirable to utilize an oppositely rotating motor in the upper housing half, such that when the upper housing half is inverted and mated with the lower housing half, the platters are rotating in the same direction relative to each other. Otherwise, there may be significant turbulence and interference in the boundary layer air adjacent each platter, which may tend to disrupt normal operation and reliability of the drive.

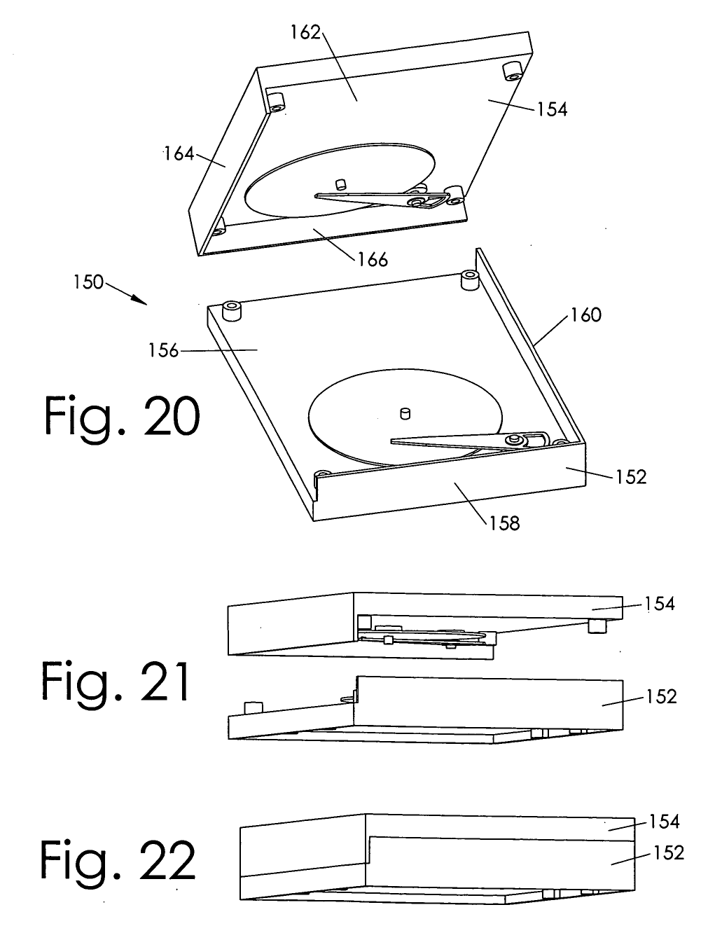

FIGS. 20-22 illustrate a similar embodiment of a multi-spindle drive 150 including a lower housing half 152 and an upper housing half 154. Rather than mating at a planar mating surface of each, with the end and side walls being equally split between the upper and lower housing halves (as in the prior embodiment), the overall housing has been differently distributed between the upper and lower housing halves. In this embodiment, each housing half comprises essentially three of the six sides of the “cube” of the overall housing. For example, the lower housing half may include the lower face 156, the front face 158, and the right face 160, while the upper housing half may include the upper face 162, the left face 164, and the rear face 166, with the six faces together defining the sealed chamber which encloses the spindles and armatures.

One advantage of mounting one platter on the lower housing half and the other on the upper housing half is that it can, in some instances, simplify the manufacturing process by preventing the need for handling a loose platter which overlaps another platter during assembly. If the loose platter were to accidentally strike the other platter or the other armature, either might be damaged. By fixing each spindle's platter(s) to its respective housing half, the likelihood of such contact can be reduced, because the housing halves may be easier to accurately handle, and the housing halves themselves may prevent contact between their respective components.

### CONCLUSION

Having two independent sets of heads accessing two independent sets of platters effectively doubles the rate at which data can be written to or read from the hard disk drive.

Reducing the diameter of the platter (versus the 3.5″ platter of the prior art) correspondingly reduces the head seek latency, because the armature is not required to swing as far in any direction. The average distance from the various cylinders to a middle cylinder is reduced.

The respective spindles' platters can be striped, or they can be mirrored.

While each spindle has been shown with only a single head reading a single side of a single platter, this is for ease of illustration only.

In some applications, the overall data capacity of the multi-spindle drive may be lower than that of a conventional, single-spindle drive using comparable technologies. However, in most applications, it may actually be higher.

Because the platters are smaller, the spindles, motors, bearings, and so forth may be made smaller and lighter, and may be subjected to lower wear than their full-size, single-spindle counterparts. This may be traded off for higher rotational velocity (rpm).

In a conventional drive, the maximum rotational speed of the platter may be limited not only by the drive characteristics of the motor, but also by the ability of the head and the media to correctly read and write data—both at the innermost cylinder which has a low tangential velocity, and at the outermost cylinder which has a much higher tangential velocity. The difference between the outermost cylinder and the innermost cylinder is significantly smaller with the reduced-size platter than with the full-size, conventional platter. This may, in many applications, enable the smaller platters to be rotated at a significantly higher rate than the full-size components could handle. This, in turn, will significantly reduce the latency and potentially increase the data transfer rate, as each given sector will pass beneath the head with much greater average frequency.

While the hard disk drive has been illustrated with two spindles, it could be constructed with three or more, with the platters being sized accordingly. In one embodiment, a single hard disk drive may even be a self-contained RAID 3 or RAID 5 system, albeit one in which an “independent drive” (or, in this case, one spindle's platters) cannot readily be swapped.

While the invention has been described with reference to hard disk drives, which are generally of the magnetic storage type, it may be practiced in the context of other rotating storage technologies, as well. For example, a single hard disk spindle and platter could occupy the same chassis as an optical spindle and platter. A short latency/high throughput spindle and platter could occupy the same chassis as a long latency/low throughput spindle and platter. In some such applications, a faster, lower capacity disk may serve as a cache and/or a buffer for a slower, higher capacity disk.

While the invention has been described with reference to specific embodiments thereof, it is not limited to the specific features or combinations illustrated. The various features illustrated in the figures may be combined in many ways, and should not be interpreted as though limited to the specific embodiments in which they were explained and shown. When one component is said to be “adjacent” another component, it should not be interpreted to mean that there is absolutely nothing between the two components, only that they are in the order indicated or at least suitably near one another. Those skilled in the art having the benefit of this disclosure will appreciate that many other variations from the foregoing description and drawings may be made within the scope of the present invention.

What is claimed is:

1. A disk drive comprising:
a chassis;
a sealed chamber within the chassis, and, within the sealed chamber,
a first spindle coupled to the chassis,
a first media platter coupled to the first spindle; and
a first read/write head coupled to the chassis for accessing the first media platter;
a second spindle, non-coaxial with the first spindle and external to the sealed chamber, for supporting at least one second media platter;
a second read/write head coupled to the chassis for accessing the at least one second media platter.

2. The disk drive of claim 1 further comprising:
the second media platter coupled to the second spindle.

3. The disk drive of claim 2 wherein:
the at least one first media platter and the at least one second media platter overlap each other.

4. The disk drive of claim 3 wherein:
the chassis includes,
a lower portion,
an upper portion, and
a step coupling the lower portion to the upper portion;
wherein one of the first and second spindles is coupled to the lower portion, and the other is coupled to the upper portion.

5. The disk drive of claim 1 wherein:
the first media platter comprises at least one of a cache and a buffer for accesses to the second media platter.

6. The disk drive of claim 1 wherein:
the first media platter has a first diameter; and
the second media platter has a second diameter different than the first diameter.

7. The disk drive of claim 6 wherein:
the first diameter is less than 50% of the second diameter.

8. The disk drive of claim 1 wherein:
the first spindle rotates at a first speed; and
the second spindle rotates at a second speed different than the first speed.

9. The disk drive of claim 1 wherein:
the first and second spindles rotate in opposite directions.

10. The disk drive of claim 1 wherein:
the first media platter comprises a magnetic hard disk platter.

11. The disk drive of claim 10 wherein:
the second media platter comprises a magnetic hard disk platter coupled to the first spindle.

12. The disk drive of claim 10 wherein:
the second media platter comprises an optical disc coupled to the second spindle.

13. The disk drive of claim 12 wherein:
the optical disc is removable.

14. An improvement in a standard sized computer optical disc drive which includes a chassis, an optical disc spindle coupled to the chassis, and an optical read/write head coupled to access an optical disc removably coupled to the spindle, wherein the improvement comprises:
a sealed chamber within the chassis;
a hard disk spindle coupled to the chassis within the sealed chamber;
a magnetic recording platter coupled to the hard disk spindle within the sealed chamber; and
a magnetic read/write head coupled within the sealed chamber to access the magnetic recording platter;
wherein the improvement further comprises the magnetic recording platter configured to function as a cache for the optical disc.

15. The improvement of claim 14 in the standard sized computer optical disc drive, wherein the improvement further comprises:
a portion of the optical disc overlapping with a portion of the magnetic recording platter.
